(19) United States
(12) Patent Application Publication
(10) Pub. No.: US 2021/0378382 A1
(43) Pub. Date: Dec. 9, 2021

(54) GRINDING POWDER REFILL COSMETIC CONTAINER

(71) Applicant: SAMHWA CO., LTD., Uiwang-si Gyeonggi-do (KR)

(72) Inventors: Jun Hong LEE, Siheung-si Gyeonggi-do (KR); Kyung Chang LEE, Uiwang-si Gyeonggi-do (KR)

(21) Appl. No.: 17/285,227

(22) PCT Filed: Oct. 25, 2019
(86) PCT No.: PCT/KR2019/014183

§ 371 Date: Apr. 14, 2021

(30) Foreign Application Priority Data
Oct. 31, 2018 (KR) 10-2018-0132035

(51) Int. Cl. A45D 33/04; B02C 18/12; B02C 18/08

(52) U.S. Cl. CPC A45D 33/04; A45D 2033/001; B02C 18/083; B02C 18/12

(57) ABSTRACT

The present invention relates to a grinding cosmetic container, and grinds solid cosmetic contents by means of a grinding member so as to enable application of same as powdered cosmetic contents, thereby allowing cosmetic contents to be uniformly stuck to a puff and, simultaneously, allowing the cosmetic contents to be refilled and used.

### TECHNICAL FIELD

The present disclosure relates to a grinding powder refill cosmetic container. More particularly, the present disclosure relates to a grinding powder refill cosmetic container, which grinds solid cosmetic contents, i.e. solid powder and a balm type material, such as hardening cream or hardening essence, with a grinding member and then applies makeup with powdered cosmetic contents, thus causing the cosmetic contents to be uniformly applied to a puff, and allowing the cosmetic contents to be refilled and used.

### BACKGROUND ART

As described in Korean Patent Application No. 2009-101562, cosmetic powder is generally accommodated in a container in the form of a powdery substance. However, this form of cosmetic powder is problematic in that the powder is scattered when in use.

In order to solve the problem, according to the related art, the powder is compressed. However, this is problematic in that the puff should come into strong contact with the compressed powder to apply the compressed powder to the puff when in use, so that the compressed powder is not evenly applied to the puff.

Furthermore, this is problematic in that particles of the compressed powder applied to the puff are non-uniform, and waste such as a user's sweat applied to the puff during makeup is transferred to the compressed powder.

### DISCLOSURE

### Technical Problem

Accordingly, the present disclosure has been made keeping in mind the above problems occurring in the related art, and is intended to provide a grinding powder refill cosmetic container, which finely grinds solid cosmetic contents, i.e. solid powder as well as a balm type material, such as hardening cream or hardening essence, thus causing the cosmetic contents to be uniformly applied to a puff, and allowing the cosmetic contents to be refilled and used.

### Technical Solution

In an aspect of the present disclosure, a grinding powder refill cosmetic container includes a cylindrical middle case that is closed at a lower portion thereof and is opened at an upper portion thereof; a handle middle case that is a rim-shaped member coupled to an inner circumference of the middle case via a hinge, a locking protrusion being formed on an outer circumference of an upper portion of the handle middle case to be fastened to a rotary-ring member, which will be described later, in a screw-type fastening method; a conical spring installed so that an inner circumference thereof is supported by a plurality of projections that protrude from a bottom surface of the middle case and are arranged in a circumferential shape; a support guide that is located above the conical spring, is a cylindrical member opened at an upper portion thereof and closed at a lower portion thereof, and is moved up and down along an inner circumferential wall of the middle case by tension of the conical spring; a refill-container support member that is a cylindrical member inserted into the support guide, closed at a lower portion thereof, and opened at an upper portion thereof, and has on an outer circumference of an upper portion thereof a plurality of outer circumferential projections that are seated on a plurality of notches formed on an upper end of the support guide to prevent the refill-container support member from rotating; a cosmetic refill container coupled to an inside of the refill-container support member to come into close contact therewith, and containing solid cosmetic contents therein; a grinding member having a plurality of blade holes that are radially formed about a central point on a closed lower surface, and opened at an upper portion thereof, a flange portion being formed on an open outer circumference; a rotary-ring member coupled to an outer circumference of an upper end of the middle case to hold the flange portion of the grinding member and thereby rotate the grinding member; a puff cover having on a center thereof a handle to cover a puff inserted into the grinding member; a lower case that is a member surrounding the lower portion and a lower side of the middle case, an open and close button thereof being coupled to one side of an upper portion of the lower case, a hinge portion thereof being formed on the other side of the upper portion thereof; and an upper case that is a member covering the upper portion of the handle middle case, a hinge projection thereof being hinged to the hinge portion of the lower case, an open and close projection thereof being inserted into the open and close button.

The locking protrusion may be formed on the outer circumference of the upper end of the handle middle case to engage with and be coupled to an inner circumferential projection of the rotary-ring member.

### Advantageous Effects

A grinding cosmetic container of the present disclosure has effects of allowing cosmetic contents to be uniformly applied to a puff and allowing the cosmetic contents to be refilled and used, by grinding solid cosmetic contents with a grinding member and then allowing make-up to be applied with powdered cosmetic contents.

### DESCRIPTION OF DRAWINGS

FIG. 1 is an exploded perspective view of a grinding cosmetic container according to the present disclosure when seen from above;

FIG. 2 is an exploded perspective view of the grinding cosmetic container according to the present disclosure when seen from below;

FIG. 3 is a sectional view showing the grinding cosmetic container of the present disclosure when it is assembled;

FIG. 4 is a sectional view taken along line A-A of FIG. 3;

FIG. 5 is a sectional view showing a state in which a support guide of the grinding cosmetic container of the present disclosure moves upwards; and

FIG. 6 is a perspective view showing a state in which an upper case of the grinding cosmetic container of the present disclosure is opened.

### BEST MODE

Hereinafter, preferred embodiments of the present disclosure will be described in detail with reference to the accompanying drawings. In addition, when it is determined that the detailed description of a known configuration or function related to the present disclosure may obscure the gist of the present disclosure, the detailed description will be omitted.

### Embodiment

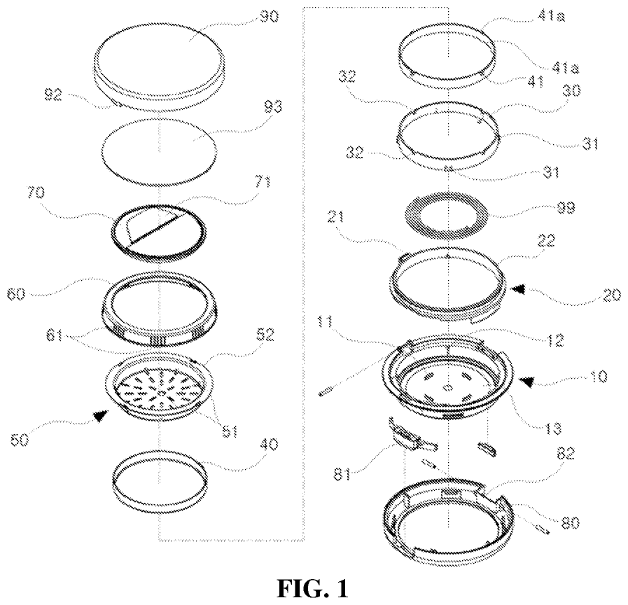

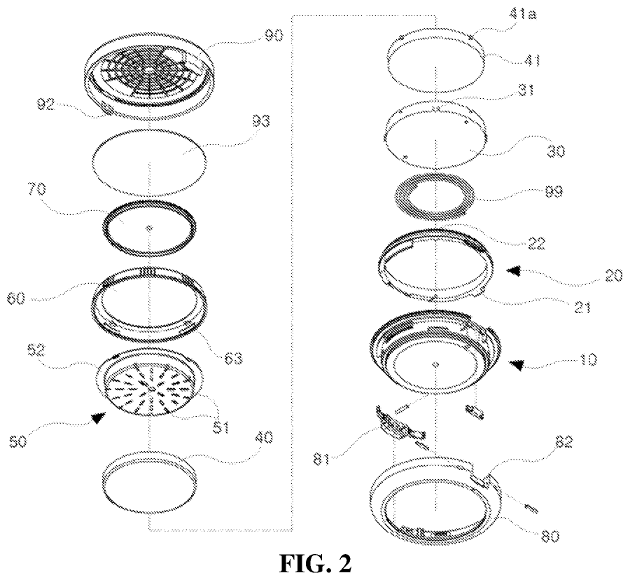

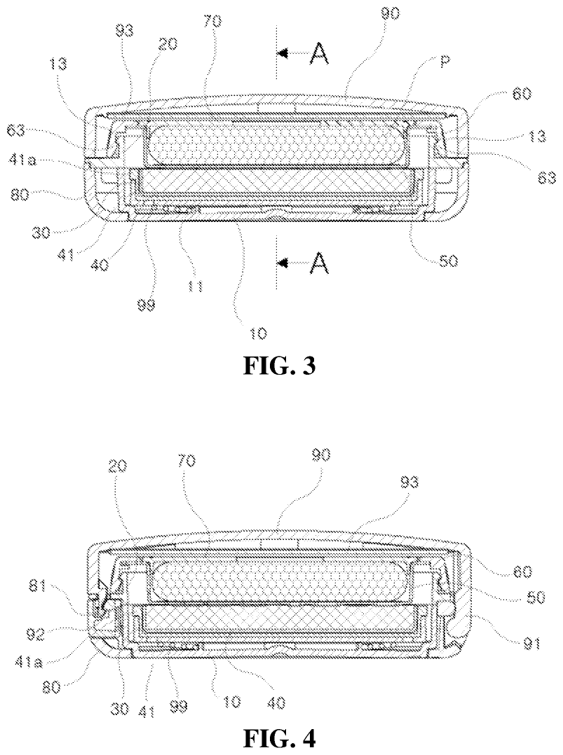

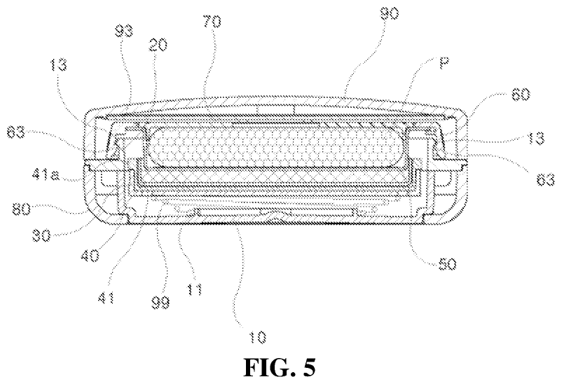

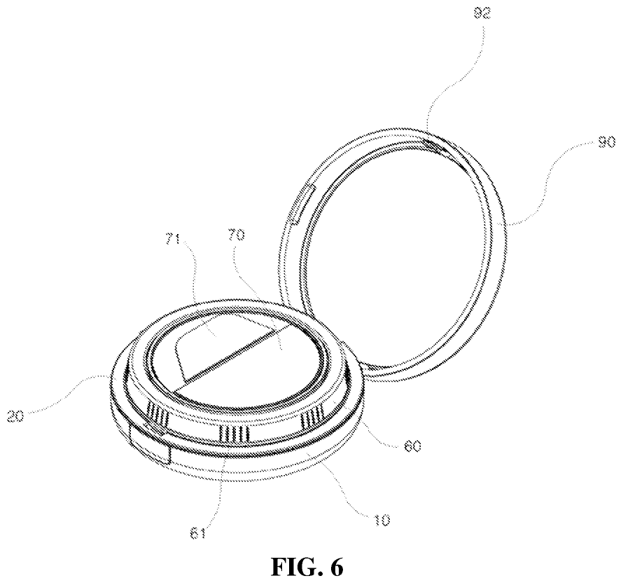

FIG. 1 is an exploded perspective view of a grinding cosmetic container according to the present disclosure when seen from above, FIG. 2 is an exploded perspective view of the grinding cosmetic container according to the present disclosure when seen from below, FIG. 3 is a sectional view showing the grinding cosmetic container of the present disclosure when it is assembled, FIG. 4 is a sectional view taken along line A-A of FIG. 3, FIG. 5 is a sectional view showing a state in which a support guide of the grinding cosmetic container of the present disclosure moves upwards, and FIG. 6 is a perspective view showing a state in which an upper case of the grinding cosmetic container of the present disclosure is opened.

As shown in FIGS. 1 to 6, the grinding cosmetic container of the present disclosure includes a cylindrical middle case 10 that is closed at a lower portion thereof and is opened at an upper portion thereof; a handle middle case 20 that is a rim-shaped member coupled to an inner circumference of the middle case 10 via a hinge 21, a locking protrusion 22 being formed on an outer circumference of an upper portion of the handle middle case to be fastened to a rotary-ring member, which will be described later, in a screw-type fastening method; a conical spring 99 installed so that an inner circumference thereof is supported by a plurality of projections 11 that protrude from a bottom surface of the middle case 10 and are arranged in a circumferential shape; a support guide 30 that is located above the conical spring 99, is a cylindrical member opened at an upper portion thereof and closed at a lower portion thereof, and is moved up and down along an inner circumferential wall of the middle case 10 by tension of the conical spring 99; a refill-container support member 41 that is a cylindrical member inserted into the support guide 30, closed at a lower portion thereof, and opened at an upper portion thereof, and has on an outer circumference of an upper portion thereof a plurality of outer circumferential projections 41a that are seated on a plurality of notches 32 formed on an upper end of the support guide 30 to prevent the refill-container support member from rotating; a cosmetic refill container 40 coupled to an inside of the refill-container support member 41 to come into close contact therewith, and containing solid cosmetic contents therein; a grinding member 50 having a plurality of blade holes 51 that are radially formed about a central point on a closed lower surface, and opened at an upper portion thereof, a flange portion 52 being formed on an open outer circumference; a rotary-ring member 60 coupled to an outer circumference of an upper end of the middle case 10 to hold the flange portion 52 of the grinding member 50 and thereby rotate the grinding member 50; a puff cover 70 having on a center thereof a handle 71 to cover a puff P inserted into the grinding member 50; a lower case 80 that is a member surrounding the lower portion and a lower side of the middle case 10, an open and close button 81 thereof being coupled to one side of an upper portion of the lower case, a hinge portion 82 thereof being formed on the other side of the upper portion thereof; and an upper case 90 that is a member covering the upper portion of the middle case 10, a hinge projection 91 thereof being hinged to the hinge portion 82 of the lower case 80, an open and close projection 92 thereof being inserted into the open and close button 81.

A mirror 93 is attached to an inner surface of a lower portion of the upper case 90.

A plurality of rotary projections 61 protrudes from the outer circumference of the rotary-ring member 60 so as to hold and turn the rotary-ring member by hand.

The support guide 30 has on its outer circumference a guide projection 31 in the form of a groove, and an inner circumferential wall projection 12 protruding vertically from the inner circumferential wall of the middle case 10 is inserted into the groove defined by the guide projection 31, so that the support guide 30 is vertically moved up and down.

The locking protrusion 22 is formed on the outer circumference of the upper end of the handle middle case 20 to engage with and be coupled to an inner circumferential projection 62 of the rotary-ring member 60.

Next, the operation and effect of the grinding cosmetic container according to the present disclosure configured as described above will be described.

First, the assembly process of the grinding cosmetic container will be described. The conical spring 99 is installed on the bottom of the middle case 10, and the support guide 30 is located above the conical spring 99, and the inner circumferential wall projection 12 of the middle case 10 is inserted into the groove defined by the guide projection 31 formed on the outer circumference of the support guide 30. The cosmetic refill container 40 containing the cosmetic contents is inserted into the support guide 30, and the grinding member 50 is located above the cosmetic refill container, i.e. the cosmetic contents, and is installed such that the blade groove 51 is located above the cosmetic contents. If the flange portion 52 of the grinding member 50 is held by the rotary-ring member 60 and the rotary-ring member 60 is pressed against the locking protrusion 22 provided on the upper end of the handle middle case 20, the inner circumferential projection 62 formed on the inner circumference of the rotary-ring member 60 engages with the locking protrusion 22 to be coupled thereto.

Further, the puff P is inserted into the grinding member, and is covered with the puff cover 70 having the handle 71 on the center of the flange portion 52 of the grinding member 50.

Furthermore, the lower case 80 is coupled to the lower portion of the middle case 10, and the hinge projection 91 of the upper case 90 is hinged to the hinge portion 82 of the lower case 80, so that the assembly is completed.

In order to use the grinding cosmetic container assembled as such, if the open and close button 81 of the lower case 80 is first pressed, the upper case 90 rotates about the hinge projection 92 to be opened. If the rotary-ring member 60 is turned with the upper case 90 being opened, the grinding member 50 is simultaneously rotated, and the cosmetic contents in the cosmetic refill container 40 are ground through the blade hole 51 formed on the lower surface, so that the cosmetic contents are introduced into the grinding member 50, i.e. the lower surface of the puff P, and a user puts on makeup using the cosmetic contents introduced into the puff.

As such, the solid cosmetic contents are ground by the grinding member 50 to put on makeup with the powdered cosmetic contents, thus allowing the cosmetic contents to be uniformly applied to the puff during makeup.

In order to refill the refill container, a user has only to lift the handle middle case 20 inserted into the middle case 10 about the hinge 21, and then replace the refill container 40 with a new one.

Although the foregoing description is merely for illustrative purposes, it is apparent to those skilled in the art that the present disclosure may be changed and modified in various ways without departing from the scope of the present disclosure, which is described in the following claims.

A grinding cosmetic container of the present disclosure has effects of allowing cosmetic contents to be uniformly applied to a puff and allowing the cosmetic contents to be refilled and used, by grinding solid cosmetic contents with a grinding member and then allowing make-up to be applied with powdered cosmetic contents.

1. A grinding powder refill cosmetic container, comprising:
a cylindrical middle case (10) that is closed at a lower portion thereof and is opened at an upper portion thereof;
a handle middle case (20) that is a rim-shaped member coupled to an inner circumference of the middle case (10) via a hinge (21), a locking protrusion (22) being formed on an outer circumference of an upper portion of the handle middle case to be fastened to a rotary-ring member in a screw-type fastening method;
a conical spring (99) installed so that an inner circumference thereof is supported by a plurality of projections (11) that protrude from a bottom surface of the middle case (10) and are arranged in a circumferential shape;
a support guide (30) that is located above the conical spring (99), is a cylindrical member opened at an upper portion thereof and closed at a lower portion thereof, and is moved up and down along an inner circumferential wall of the middle case (10) by tension of the conical spring (⁹⁹);
a refill-container support member (41) that is a cylindrical member inserted into the support guide (30), closed at a lower portion thereof, and opened at an upper portion thereof, and has on an outer circumference of an upper portion thereof a plurality of outer circumferential projections (41a) that are seated on a plurality of notches (32) formed on an upper end of the support guide (30) to prevent the refill-container support member from rotating;
a cosmetic refill container (40) coupled to an inside of the refill-container support member (41) to come into close contact therewith, and containing solid cosmetic contents therein;
a grinding member (50) having a plurality of blade holes (51) that are radially formed about a central point on a closed lower surface, and opened at an upper portion thereof, a flange portion (52) being formed on an open outer circumference;
a rotary-ring member (60) coupled to an outer circumference of an upper end of the middle case (10) to hold the flange portion (52) of the grinding member (50) and thereby rotate the grinding member (50);
a puff cover (70) having on a center thereof a handle (71) to cover a puff (P) inserted into the grinding member (50);
a lower case (80) that is a member surrounding the lower portion and a lower side of the middle case (10), an open and close button (81) thereof being coupled to one side of an upper portion of the lower case, a hinge portion (82) thereof being formed on the other side of the upper portion thereof; and
an upper case (90) that is a member covering the upper portion of the middle case (10), a hinge projection (91) thereof being hinged to the hinge portion (82) of the lower case (80), an open and close projection (92) thereof being inserted into the open and close button (81).

2. The grinding powder refill cosmetic container of claim 1, wherein the locking protrusion (22) is formed on the outer circumference of the upper end of the handle middle case (20) to engage with and be coupled to an inner circumferential projection (62) of the rotary-ring member (60).
